(19) United States
(12) Patent Application Publication
(10) Pub. No.: US 2009/0219218 A1
(43) Pub. Date: Sep. 3, 2009

(54) APPARATUS FOR ROTATION OF A LARGE BODY ABOUT AN AXIS

(76) Inventor: Stephen Kaneff, Red Hill (AU)

Correspondence Address: SCULLY SCOTT MURPHY & PRESSER, PC, 400 GARDEN CITY PLAZA, SUITE 300, GARDEN CITY, NY, 11530, US

(21) Appl. No.: 12/467,027

(22) Filed: May 15, 2009

Related U.S. Application Data
(63) Continuation of application No. 10/577,689, filed on Apr. 28, 2006.

(30) Foreign Application Priority Data
Oct. 28, 2003 (AU) 2003905934

(51) Int. Cl. H01Q 3/00

(52) U.S. Cl. 343/766

(57) ABSTRACT

Apparatus for the rotation of a large body, such as the base frame of a solar energy collector having a large reflective dish, about an axis utilizes a ring member or arcuate member. An actuator clamp is movable along the ring or arcuate member when it is not clamped to it. The actuator clamp is connected to one end of an expansion and contraction device, such as a hydraulic ram. The other end of the hydraulic ram is connected to the body, to a projection from the body, or to a rigid arm that is securely connected to the body. With the actuator clamp firmly clamped to the ring or arcuate member, actuation of the hydraulic ram causes the body to rotate about the axis.

### CROSS-REFERENCE TO RELATED APPLICATION

This application is a continuation-in-part of U.S. patent application Ser. No. 10/577,689, filed Apr. 28, 2006, which was derived from International (PCT) patent application No. PCT/AU2004/001474.

### TECHNICAL FIELD

This invention concerns the rotation of a body about an axis. More particularly, it concerns the controlled rotation (which includes partial rotation) of a large body about an axis, and (in one special situation) linear movement of a large body.

This invention was developed to provide effective actuation and control of the rotation of structures on which are mounted large dish antennae, such as the dish antennae used in radio telescopes, solar energy collectors and satellite communication systems, and in particular the large solar energy collector dish antennae described in the specifications of U.S. Pat. Nos. 5,757,335 and 5,934,271, and corresponding Australian patents Nos. 677,257 and 700,607. For this reason, the large dish antenna application of the invention will be featured in this specification. However, it should be appreciated that the present invention is not limited in its application to the rotation of such structures.

It should also be appreciated that the present invention is not constrained with regard to the radius of rotation of the body, which, in the special situation noted above, may be infinite (that is, with suitable guide arrangements, the invention can provide linear motion of the body). With finite radii of rotation, the allowable rotation of the body, clockwise or counterclockwise, can be more than 360°, if necessary.

### BACKGROUND TO THE INVENTION

Antennae for receiving signals from satellites or radio stars, and for receiving solar energy, often employ a large reflecting dish to focus electromagnetic radiation onto a receiver placed at the focus of the dish. The dish, comprising a reflective or conductive surface mounted on a rigid support frame or structure, is physically moved so that the pointing axis (also called the sighting axis) of the dish tracks, or points directly at, the source of the electromagnetic radiation. This movement is normally about two axes, usually being rotation about a vertical axis and a horizontal axis (the so-called “azimuth/altitude tracking”). Less frequently, the dishes may be actuated on polar and equatorial axes (to effect “polar/equatorial tracking” of the radiation source). In the case of a large solar energy collector, various design considerations have led to the use of azimuthialtitude tracking being favored.

The conventional technique for effecting rotation of a large antenna structure about a vertical axis involves the use of a motor which drives a pinion that engages with a toothed track. Usually, the track is constructed in an arcuate or circular form with the required axis of rotation also being the centre of curvature of the arc or circle. The motor, which may be either electrically or hydraulically powered, drives the pinion through a reduction gearbox so that the antenna is rotated slowly, but continuously, about the required axis.

The electric or hydraulic motor required to rotate large bodies, and the reduction gearbox, are expensive components. Also, the operational strategy that is used, in the case of large solar energy collectors, is to actuate the antenna structure in a manner that is not truly continuous, but is intermittent. Accordingly, the dish of a large solar energy collector is usually rotated intermittently in steps, with a period of rest (that is, with a period in which there is no rotational movement) between each period of step rotation. This strategy avoids the need for extra power that would otherwise be required to suppress the “hunting” phenomenon that can occur when buffeting winds act on dishes that are being truly continuously rotated. (This “hunting” can be reduced by suitable design of the dish, as shown in the specifications of Australian patent No. 700,607 and U.S. Pat. No. 5,934,271, but it cannot be eliminated.) Thus large solar energy collectors are now usually operated in a 10 manner that allows correction of the orientation of the pointing axis of the reflector every few seconds (the actual period between actuations depends upon the time of day, and the consequent different apparent motion of the sun in relation to each tracking axis). This approach is potentially more economical in terms of the total amount of energy used to track the sun. However, in the case of movement of the antenna by a motor and pinion drive, transients of high energy demand occur during the continual starting and stopping of the motor. This presents the need for ramping drives (with appropriate switchgear) while starting and while stopping, to ameliorate the magnitude of the transients. This, in turn, makes the drive system even more expensive and potentially more prone to maintenance demands.

Another operational feature of large solar energy collectors is that, in the event that there is a failure of the tracking drive power, the antenna must be “off-steered” rapidly to avoid damage to the solar energy receiver. An “off-steering” device requires a back-up power supply, typically a bank of batteries which require regular maintenance, and this adds to the cost of the tracking equipment.

An alternative mechanism for rotating large solar energy collectors and other large bodies is described in the specification of U.S. Pat. No. 5,757,335 (and also in the specifications of European patent No. 1182356 and Australian patent No. 677,335). That mechanism, which its inventors called “a walking ram” mechanism, involves an arm attached to or forming part of the body to be rotated, a hydraulic ram having its ram cylinder connected to the arm, and a plurality of 5 substantially equi-spaced anchor members, in the form of upright stanchions or pillars, which lie on a circle or an arc of a circle. The plane of this circle or arc is orthogonal to the axis of rotation of the body. Activation of the ram moves the ram cylinder relative to the anchor members, and thus moves the arm and causes the body to rotate about the axis. The end of the ram rod of the hydraulic ram which is remote from the ram cylinder is guided from one anchor member to an adjacent anchor member, where it is locked in place while the ram is activated.

The description of this “locking in place” action in the specification of U.S. Pat. No. 5,757,335 (and in the specifications of the corresponding European patent No. 1182356 and Australian patent No. 677,335) lack detail. However, being a co-inventor of the “walking ram arrangement, I am aware that to achieve that “locking in place”, a separate arm (not shown in the drawings of those patent specifications) is required. That separate or extra arm extends from, and is rigidly attached to, the base frame of the large dish antenna described in those specifications. That separate arm is positioned so that when:
a. the hydraulic ram 84 (the reference numerals here are those of the drawings of the specifications of U.S. Pat. No. 5,757,335, European patent No. 1182356 and Australian patent No. 677,335) reaches the position where the hydraulic ram has been contracted to the point where its contraction ceases, and
b. the end of the ram rod 86 which has been connected to the anchor member 85a is to be released from that anchor member, the separate arm can be locked to one of the other anchor members.

The locking of the separate arm to that other anchor member requires the precise alignment of a locking member on the separate arm with a locking member on that other anchor member. As soon as the locking of the separate arm has been effected, the end of the ram rod 86 is released from the anchor member 85a and is moved, by the expansion of the ram 84, until it is aligned with, and is connected to, the next anchor member 85b. The extra arm is then unlocked from its anchor member. Only then can the ram 84 be contracted to continue the rotation of the arm 8 1 (and, with it, the “body” being rotated and its attached extra arm) in the direction of the arrow 87 (FIG. 8).

There are two major consequences of this “walking ram” arrangement. The first is that the throw of the hydraulic ram 84 can never be varied, but has to be exactly sufficient to ensure that, when the contraction of the ram is complete, the extra (separate) arm has been moved so that its locking member is aligned precisely with the locking member of the next anchor member. The second is that the positioning of the anchor members (which are stanchions or pillars) has to be very precise (in fact, the nature of the locking arrangement is such that the location of the anchor members must be accurate to within 2 mm). This means that the installation of the pillars or anchor members (of which there are eighteen in the large dish antenna for which the system was devised) and their associated locking members (which co-operate with the locking member on the extra arm) requires great engineering skill).

This last point is accentuated if fewer anchor members are used, with the consequential need for rams of longer stroke or “throw”. Experience has shown that, even with eighteen carefully mounted anchor members, a number of 25 operational conditions and factors can combine to cause the engagement of the end of the ram rod with the new anchor member to fail, even when care is taken to calibrate the whole system to more accurately locate the positions of the anchor members in the memory of the control computer, to ease the problem of the rod end failing to locate and lock onto the next anchor member. Techniques that may be employed to avoid this situation result in an increased cost and complexity of the system. An increased complexity would mean that more maintenance is likely to be required.

Another disadvantage of the “walking ram” arrangement is that, in spite of rapid computer control processes, the time taken for the end of the rod 86 to move from a particular anchor member to the adjacent anchor member is significant (being of 10 the order of 15 seconds). This time period can cause a momentary undesirable tracking delay, allowing the receiver to lag slightly behind the sun. (This problem can be ameliorated by deliberately causing the dish structure to move slightly ahead of its required position just before the changeover maneuver commences, but this requires extra control functions and tracking energy.) It also demonstrates that the “walking ram” mechanism provides its associated large antenna with a step-wise azimuthal rotation, with the size of the “steps” being identical and non-variable.

Nevertheless, step-wise rotation is acceptable for a solar energy collector having a large dish antenna which tracks the sun, and the “walking ram” rotation mechanism (of U.S. Pat. No. 5,757,335, European patent No. 1182356 and Australian patent No. 677,335) has been used with such solar collectors because
a) it is substantially less costly than the conventional drive motor with its associated accurately laid track (with which the pinion driven by the motor engages), and
b) it will rotate a large solar collector antenna at least as effectively as the conventional motor and pinion drive mechanism.

In addition, its “off-steering” mechanism, for emergency use in the event of a power failure, can be the same hydraulic ram arrangement, driven by pressurized gas from a cylinder of the gas.

### DISCLOSURE OF THE PRESENT INVENTION

It is an object of the present invention to provide a new mechanism for rotating a large body about an axis, which is suitable for use with large dish antennae, and which (a) is both less costly and more reliable than both the conventional motor and pinion arrangement and the “walking ram” mechanism described above, and (b) is also suitable for the rotation of other large bodies.

This objective is achieved by positioning the body to be rotated within, above or below a ring member or an arcuate member, the ring member or arcuate member having an uppermost surface which is positioned in a plane, with the centre of curvature of the ring or arcuate member being on the axis of rotation of the body. The body is connected (via a rigid arm or a rigid projection from the body, if necessary) to one end of an expansion and contraction device preferably a linear expansion and contraction device, such as a hydraulic ram arrangement or an electrically powered turnbuckle). The other end of the expansion and contraction device is connected to a clamp (an actuator clamp) which is positioned to clamp firmly to the ring or arcuate member, but which, when not so clamped, can be moved along the ring or arcuate member. The body is rotated about its axis of rotation when the clamp is clamped onto the ring member or arcuate member, and the expansion and contraction device is activated to be expanded or contracted for a predetermined “throw” of the expansion and contraction device. The end of the expansion and contraction device which is remote from the clamp is thus moved, and the body is also moved, either directly or as a consequence of the movement of the arm that is attached rigidly to the body (or the rigid projection from the body). That movement translates into rotation of the body about its axis of rotation. Thus it is preferred that the expansion and contraction device is a linear expansion and contraction device that is mounted so that its elongate direction is substantially tangential to the ring or arcuate member.

At the conclusion of the throw of the expansion and contraction device, release of the actuator clamp, followed by actuation of the linear expansion and contraction device in the opposite direction, leaves the body at rest in its new position and causes the actuator clamp to move along the ring or arcuate member until a fresh clamping position is reached. In this new clamping position, the actuator clamp is again clamped to the ring member or arcuate member and the procedure described above is repeated.

The throw of the expansion and contraction device will normally be variable, and the extent of the predetermined throw will be chosen to suit the conditions under which the body is being rotated. Therefore, if essentially continuous rotation of the body is required, a short throw of the expansion and contraction device will 15 be adopted, with rapid actuation and de-actuation of the clamp and of the expansion and contraction device. (With modem switching techniques, the time for such rapid actuation and de-actuation can be imperceptibly short.) If the present invention is to be used with a solar energy collector having a large dish antenna which tracks the sun, for which step-wise rotation is acceptable, a longer throw of the expansion and contraction device can be adopted, and a substantial improvement over the control of the rotation, compared with the “walking ram” arrangement described above, can be achieved.

Preferably, while the actuator clamp is released from the ring or arcuate member, and is being moved to its new clamping position, at least one further or auxiliary 25 actuator clamp, connected to the body (via an associated rigid arm, if necessary) is actuated so that it is clamped to the ring or arcuate member to hold the body steady and negate any adverse effect of wind on the body. When this (or each) auxiliary clamp is activated (so that it does not clamp onto the ring member or arcuate member), it moves along the ring or arcuate member as the body rotates.

When essentially continuous rotation of said body is required, the at least one auxiliary clamp will be connected to the body (or to a rigid arm or projection rigidly connected to said body) via a respective further linear expansion and contraction device. As explained below, the auxiliary clamp (or clamps) so connected to the body will enable essentially (or truly) continuous rotational movement of the body to be effected, by using the (or an) auxiliary clamp to continue the rotational movement of the body while the actuator clamp is being moved from one position on the ring member or arcuate member to another position on the ring member or arcuate member.

In more detail, essentially continuous rotational movement of the body is achieved in the following manner. To rotate the body about its axis of rotation,
1) the actuator clamp is deactivated (it is clamped onto the ring member or arcuate member),
2) the (or each) auxiliary clamp is activated, so that it is free to move along the ring member or arcuate member, and
3) the expansion and contraction device connected to the actuator clamp is actuated to be expanded or contracted for a predetermined “throw” of that expansion and contraction device.

The end of the linear expansion and contraction device which is remote from the actuator clamp is thus moved, and the body is accordingly moved, either directly or 25 as a consequence of the movement of the arm (or projection) that connects an end of the expansion and contraction device rigidly to the body. That movement translates into rotation of the body about its axis of rotation, and the simultaneous movement of the (or each) auxiliary clamp along the ring or arcuate member.

At the conclusion of the throw of the expansion and contraction device,
1) The (or an) auxiliary clamp is deactivated (it is clamped onto the ring 5 member or arcuate member),
2) the actuator clamp is activated (its grip on the ring member or arcuate member is released), and
3) the linear expansion and contraction device connected to the auxiliary clamp is actuated to be expanded or contracted for a predetermined “throw” of that expansion and contraction device.

The end of the linear expansion and contraction device which is remote from the auxiliary clamp is thus moved, and the body is accordingly moved, either directly or as a consequence of the movement of the arm (or projection) that rigidly connects an end of the expansion and contraction device to the body. During such 15 movement the actuator clamp is free to move along the ring member or arcuate member while its associated expansion and contraction device is either expanded or contracted, until a fresh clamping position is reached at the conclusion of the throw of the expansion and contraction device associated with the auxiliary clamp. In this fresh clamping position, the actuator clamp is again clamped to the ring or arcuate member and the procedure described above is repeated. Since the actuation (into a clamping mode) and de-actuation or activation (the non-clamping mode) of the actuator clamp and the auxiliary clamp can be effected with an almost imperceptible delay, and the starting and stopping of the operation of an expansion and contraction device can be achieved with the same almost imperceptible delay, there is, effectively, no interruption to the rotation of the body. In other words, effectively, there is essentially continuous rotation of the body.

To effect truly continuous rotation of the body, the procedure described above (for essentially continuous rotation) is adopted, but the (or an) auxiliary clamp and its associated expansion and contraction device may be actuated as the expansion and contraction device associated with the actuator clamp is concluding its expansion and contraction, so that the auxiliary clamp has already taken over the control of the rotation of the body when the acuator clamp is de-actuated.

From the above discussion of the present invention and the closest known prior art, it will be seen that, in its broadest form, the present invention provides apparatus for effecting the controlled rotation of a body about an axis; said apparatus comprising a ring member or arcuate member; said ring member or arcuate member having an uppermost surface which is positioned in a plane; the centre of curvature of said ring member or arcuate member being at said axis of rotation of said body; said axis of rotation being perpendicular to said plane; characterized in that:
a) an actuator clamp is mounted on said ring member or arcuate member for movement therealong, said actuator clamp being releasably clampable onto said ring member or arcuate member; and
b) an expansion and contraction device, having two end connections that are moveable substantially towards and away from each other for a predetermined throw of said device, has one of said end connections connected to said actuator clamp and the other of said end connections connected to said body, or to a rigid arm or projection connected rigidly to said body, and therefore rotatable about said axis with said body.

From the above description, it should be apparent that
1. when said actuator clamp is clamped onto said ring member or arcuate member and said expansion and contraction device is actuated to move said end connections towards or away from each other, said body (or said rigid arm and hence said body) is rotated about said axis of rotation, and
2. when said expansion and contraction device has reached the end of its throw, said actuator clamp may be released, then moved, by the further actuation of said expansion and contraction device, along said ring member or arcuate member to a fresh position thereon, so that said actuator clamp may be clamped again onto said ring member or arcuate member to permit further rotational movement of said body by further actuation of said expansion and contraction device.

As noted above, preferably
1. said expansion and contraction device is a linear expansion and contraction device, positioned with the line between its end connections (the elongate direction of the linear expansion and contraction device) being above, and substantially tangential to, said ring member or arcuate member; and

2. at least one auxiliary clamp is also mounted on said ring member or arcuate member for movement therealong, said or each auxiliary clamp being releasably clampable onto said ring member or arcuate member; said or each auxiliary clamp being connected to said body or to a respective rigid arm or projection that is rigidly connected to said body; said or each auxiliary clamp preferably being connected to said body (or to said respective rigid arm or projection that is rigidly connected to said body) by a respective further expansion and contraction device.

These and other features of the present invention (some optional) will be exemplified in the following description of embodiments of the present invention, which is provided by way of illustration only. In the following description, reference will be made to the accompanying drawings.

### BRIEF DESCRIPTION OF THE ACCOMPANYING DRAWINGS

These and other objects, features and advantages of the present invention will become apparent from the following detailed description of illustrative embodiments thereof, which is to be read in connection with the accompanying drawings, in which:

FIG. 1 is a schematic sketch of a dish antenna, mounted on a base frame which is rotatable about a vertical axis by the present invention;

FIG. 2 is a schematic plan view of another dish antenna, also mounted on a base 5 frame which is rotatable about a vertical axis by the present invention;

FIG. 3 illustrates a further embodiment of a body mounted on a base frame which is rotatable about a vertical axis by the present invention;

FIG. 4 is a partly schematic top view of a dish antenna mounted for movement along an arcuate member in the form of a wall or rail, the radius of curvature of 10 this arcuate member being infinite;

FIG. 5 shows one form of clamp that may be used in the rotation arrangements depicted in FIGS. 1, 2, 3, and 4; and

FIG. 6 illustrates a different clamp construction that may be used in the rotation arrangements depicted in FIGS. 1, 2 or 3, and 4.

### DETAILED DESCRIPTION OF THE ILLUSTRATED EMBODIMENTS

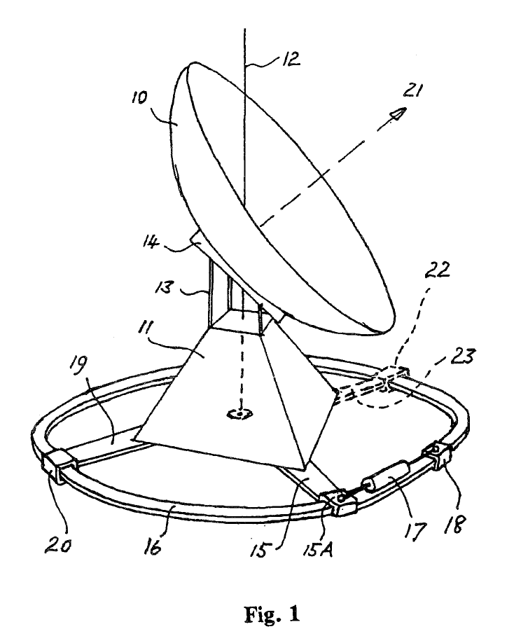

In this specification, including the claims, “directional” terms (such as “top”, “below”, “uppermost” and the like) will be used in the sense that these terms would have with reference to an embodiment of the invention positioned as shown in FIG. 1 of the accompanying drawings.

FIGS. 1 and 2 each show, schematically, a dish antenna to be rotated about a vertical axis 12. The dish antenna for which the present invention was developed is a large solar energy collector which has been assembled at The Australian National University, in Canberra, Australia. That solar energy collector has been described in the specifications of, inter alia, U.S. Pat. Nos. 5,757,335 and 5,934,271. However, it is emphasized that the solar energy collector and the dish antennae featured in FIGS. 1 and 2 are only examples of a rotatable structure with which the present invention may be used, and the present invention is not limited in its application to solar energy collectors generally, or to rotatable antennae.

The antennae illustrated in FIGS. 1 and 2 each have a dish 10 supported on a base frame 11. The support of the dish on the base frame is shown schematically in 5 FIG. 1 by columns 13 and a support unit 14. The support unit 14 includes a known form of mechanism for pivotally moving the dish 10 about a horizontal tilt axis (not shown in the drawings), to change the elevation of the line of sight (or pointing axis) 21 of the dish. Typically, a change of the elevation of the pointing axis 21 of the dish is effected using a hydraulic ram arrangement which controls the movement of a sub-frame. However, any other suitable drive mechanism (such as a screw drive or a rack and pinion mechanism, or a modified form of the present invention) may be used for this purpose.

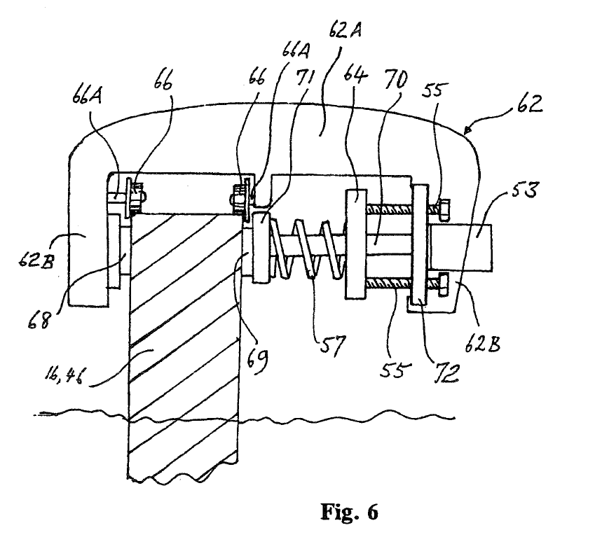

The base frame 11 (as indicated above) is mounted for rotation about a vertical axis 12. The axis 12 is at the centre of a circular track, or ring member 16. In conventional 15 large dish antenna structures, the ring member 16 is a circular toothed track and rotation of the base frame about the vertical axis is effected by motors which drive pinions that engage with the “teeth” of the toothed track. In the present invention, a toothed circular track is not required. The ring member 16 may be any convenient structure onto which a clamp may be rigidly attached. Preferably, the ring member 16 of FIGS. 1 and 2 is a circular I-beam, or a wall structure, or a circular foundation for a dish antenna, onto which clamps of the type illustrated in FIG. 5 or FIG. 6 may be mounted.

The base frame 11 of the dish antenna of FIG. 1 has a rigid arm 15 rigidly attached to it. The end 15A of the arm 15 is constructed so that it can be moved 25 freely along the ring member 16, or it has a device attached to it that can be moved freely along the ring member 16.

An actuator clamp 18 is mounted on the ring member 16. The actuator clamp 18 grips the circular ring member 16 by virtue of a force (which may conveniently be provided, for example, by a compressed spring) which is maintained continuously, unless released (de-actuated) by deliberate action of a clamp release device, which may be hydraulically (or otherwise) operated. Such release of the clamp is made only whenever it is required to move the location of the actuator clamp 18 to a new position on the ring member 16.

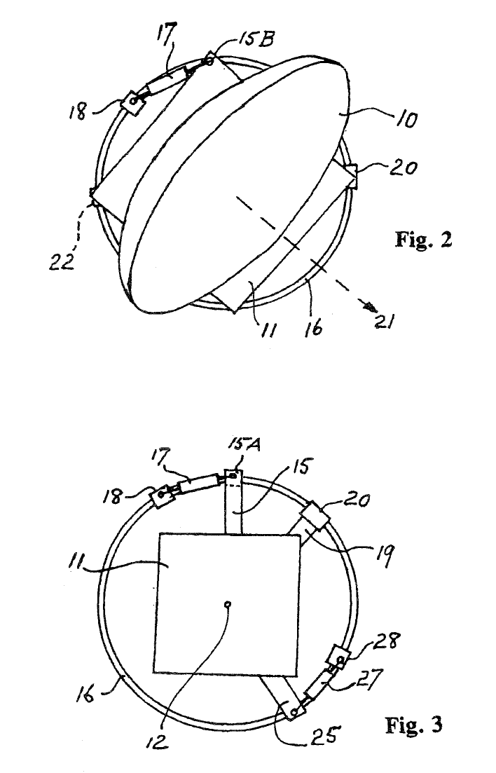

The actuator clamp 18 is connected to the end of the arm 15 which is remote from the base frame 11 by a linear expansion and contraction device, namely (in the arrangement shown in FIG. 1) a double-acting hydraulic ram 17. Another device which performs the same expansion and contraction function as the double-acting ram 17 may be used in its place. As shown in FIG. 1 (and also in FIGS. 2 and 3), the double-acting ram 17 is essentially above the ring member 16, with its elongate direction aligned substantially tangentially to the ring member 16.

An auxiliary clamp 20 is also mounted on the ring member 16. The auxiliary clamp 20 is rigidly connected to a second rigid arm 19 which, in turn, is rigidly connected to the base frame 11. The auxiliary clamp 20 also grips the ring member firmly unless it is deliberately released (de-actuated).

To rotate the base frame 11 about the axis 12
1. the actuator clamp 18 is maintained in its clamping mode,
2. auxiliary clamp 20 is released (activated), and
3. the double-acting ram 17 is expanded or contracted.

If the ram 17 is expanded, the arm 15 is forced away from the actuator clamp 18 so that the base frame 11 is rotated about the axis 12 (and the arm 19, with its associated clamp 20 is also moved) in a clockwise direction. If the ram 17 is contracted, the arm 15 is moved towards the clamp 18 and the base frame is rotated about the axis 12 (and the arm 19, with its associated auxiliary clamp 20, is also moved) in an anti-clockwise direction.

When the required (or maximum possible) expansion or contraction (throw) of the ram 17 has occurred, the clamp 20 is actuated (it is clamped onto the ring member 16) and the clamp 18 is released. Actuation of the ram 17 now causes the clamp 18 to move along the ring member 16 until it reaches a new required position. The clamp 18 is then actuated as the clamp 20 is released, and the ram 17 is again operated to move the arm 15 (and also the arm 19 and the released clamp 20) and to further rotate the base frame I1 about the axis 12.

It should be apparent that the clamp 20, via its associated rigid arm 19, holds the base frame 11 rigidly relative to the ring member 16 while the actuator clamp 18 is 15 moved along the ring member, thus preventing unwanted movement of the dish 10 should any strong wind blow on the antenna during this time of movement of the clamp 18 to its new position on the member 16. In fact if, as will normally be the case, the ring member 16 is attached to, or comprises, the foundation of the dish antenna installation, the auxiliary clamp 20 causes the member 16 (and anything to which it is attached, for example, the foundation for the antenna) to be a “counterweight”, which further contributes to the stability of the dish antenna in gusty and strong winds.

At least one farther auxiliary clamp (clamp 22 shown schematically in dashed outline in FIG. 1) may be mounted on the ring member 16 and be connected to the base 25 frame 11 by a further rigid arm 23. The clamp 22, together with any more auxiliary clamps similarly mounted on the antenna, will provide an additional aid to the stability of the antenna while the clamp 18 is moved from one clamped position to another, particularly when the dish is tracking near the horizon. And in very strong winds, when the dish is not operational but has been moved to its “survival mode” position, with its pointing axis 21 vertically upwards, with the clamp 18 actuated and the ram 17 fully contracted, the clamp 22 and each auxiliary clamp will provide further protection against the toppling of the antenna.

The (or each) additional auxiliary clamp will normally be actuated in the same manner, and at the same time, as the auxiliary clamp 20.

The actuation of the clamp 18 and the auxiliary clamp 20 (and any further auxiliary clamp or clamps, if present), and also the actuation of the double-acting ram 17 (or an equivalent device) will normally be controlled by control signals provided by a shaft encoder (not shown in the drawings) which is mounted on the axis 12.

Referring now to FIG. 2 (in which, as in FIG. 3 also, components which are essentially the same as those which have been featured in FIG. 1 have been given the same reference numbers as in FIG. 1), it should be noted that the only major difference between the tracking or scanning antennae of FIGS. 1 and 2 is that the arms 15 and 19 (and 23) are absent from the FIG. 2 embodiment. That is because the relative sizes of the base frame of the dish antenna and the ring member 16 of the FIG. 2 embodiment are such that parts of the base frame overlap the ring member. In this situation, the actuator clamp 18 and the auxiliary clamp 20 (and clamp 22, if present) are mounted directly on the base frame, and one end of the linear expansion and contraction device (the double-acting ram 17) is connected to the base frame at 15B. The rotation of the base frame 11, and hence of the dish 10, about the axis 12 is achieved using the clamps 18 and 20 (and 22) and the expansion and contraction device 17 in the same way as these components have been used in the embodiment of FIG. 1. Further description of the operation of the embodiment illustrated by FIG. 2, therefore, is unnecessary.

The period during which the clamp 18 is released and is moved along the ring member 16 can be made very short relative to the time periods in which it is necessary to rotate the position of the base frame to cause the pointing axis of the dish to follow the motion of the sun (in the case of a solar collector) or a star (in the case of a telescope). For such very short time periods, a short “throw” of the linear expansion and contraction device 17 should be used.

Actuation and de-actuation of the clamps can be effected in very short time. Thus, as described earlier in this specification, the combination of a very short rotation time with a very short throw of the expansion and contraction device results in a rotational movement of the body being rotated in such small, and rapid, steps that it is quasi-continuous.

The position of the body (the base frame 11) being rotated, relative to the axis of rotation, can be indicated by the reading of a shaft angle transducer (or encoder), and it is this reading which is used by the computer control system to control and effect the rotation of the body. Thus it is not necessary for the actuator clamp 18 20 to be moved exactly the same distance along the ring member 16 each time the position of this clamp is changed. Also, the position of the actuator clamp on the ring or arcuate member when the actuator clamp locks onto that member is not important, except that the actuator clamp must be clamped onto the ring or arcuate member at a position at which the hydraulic ram 17 (or other linear 25 activator) is able to move the body 11 in rotation about its axis 12. The only component in a tracking dish antenna system that has to be accurately located and operated is the shaft encoder (or similar measurement device) for measurement of the body's actual angular orientation on its axis, and (in the case of a solar collector dish antenna) the appropriate sun model, which provides the sun's position at all times of the day.

It has been noted already that the rotation of the dish antenna of FIG. 1 can occur in either direction, in accordance with the computer control of the position of the dish. For solar energy collection, it is not necessary for the rotation of the dish antenna about its vertical axis to occur over one complete revolution. The sun can be adequately tracked provided the rotation can occur over ±800°, centered on true geographical north. However, for other reasons (such as orienting the dish to point away from the sun), rotation over +180°, centered on true geographical north, will be more convenient.

It is not necessary for the clamps 18 and 20 to be widely separated on the ring member 16. In fact, the position of the clamps 18 and 20 on the ring member 16 that 15 is shown in FIG. 3 is approximately that which will be used in the aforementioned solar collector constructed in Canberra. Australia.

In some applications of the present invention (for example, when the body to be rotated is an optical telescope or radio telescope), the rotation has to be truly continuous, and not quasi-continuous. That is, it is not acceptable for the rotation of the body to cease even for the short time during which there is a rapid change of the position of the actuator clamp 18 on the ring member. In this situation, an arrangement as illustrated in FIG. 3 may be used to rotate the body.

The body 11 of the FIG. 3 embodiment is rotatable about a vertical axis 12 (which is also the centre of curvature of the ring member 16), as described above, by the operation of the actuator clamp 18 and the double-acting ram 17. However, a further rigid arm 25 is rigidly connected to the body 11. One end of a second double-acting ram 27 (or similar linear expansion and contraction device) is connected to the end of the arm 25 where it overlies the ring member 16. The other end of the ram 27 is connected to an auxiliary actuator clamp 28, mounted on the ring member 16 in the same manner as the actuator clamp 18.

The rotation of the body 11 is effected using the clamp 18 and ram 17 as described above. However, shortly before that motion ceases, the auxiliary clamp 28, which has been moved to a predetermined position on the ring member 16, is clamped 10 onto the ring member 16 and, simultaneously, the ram 27 is actuated to assist in the conclusion of the rotational movement initiated by the ram 17 and to take over the task of rotating the body 11 while the clamp 18 is released from the ring member and moved to its new position. When the ram 27 is nearing the end of its throw with the clamp 28 clamped to the ring member 16, the clamp 18, which is now in its new position, is clamped to the ring member I6 and the hydraulic ram 17 is actuated to assist in the final stage of the rotation of the body by the action of the ram 27 and to take over the rotation of the body while the auxiliary clamp 28 is released from the ring member and moved to its next position.

This alternate, but slightly overlapping, use of the combination of (a) the actuator clamp 18 and its associated ram 17, and (b) the auxiliary clamp 28 and its associated ram 27, then continues under the control of the microprocessor that monitors the shaft encoder, which shows the orientation of the body 11 relative to its axis of rotation 12. Truly continuous rotation of the body 11 is thus achieved.

It will be appreciated that, in a similar way, three (or more) clamps, each with an 25 associated expansion and contraction device, could be used to effect truly continuous rotation of the body 11. With such an arrangement, continuous rotation of the body can be maintained if one of these three (or more) hydraulic rams (or other linear expansion and contraction devices) should fail.

It should also be appreciated that if the arrangement shown in FIG. 3 (or an arrangement with three or more actuator clamps) is adopted, the auxiliary clamp 20 has become a redundant clamp during the rotation of the base frame. However, an auxiliary clamp 20, without an associated expansion and contraction device, may be retained in the arrangement for additional secure clamping of a dish antenna when the rotation of the body 11 is stopped. Such a situation will occur, for example, if a solar energy collector with a large dish is stopped either (a) because it is being buffeted by strong winds, or (b) between dusk and dawn, when the sun is not over the horizon.

In each of the arrangements featured in FIGS. 1,2 and 3, the ring member may be replaced with an arcuate member if complete rotation of the body is never required. 15 Such an arcuate member would have its centre of curvature at the axis of rotation 12.

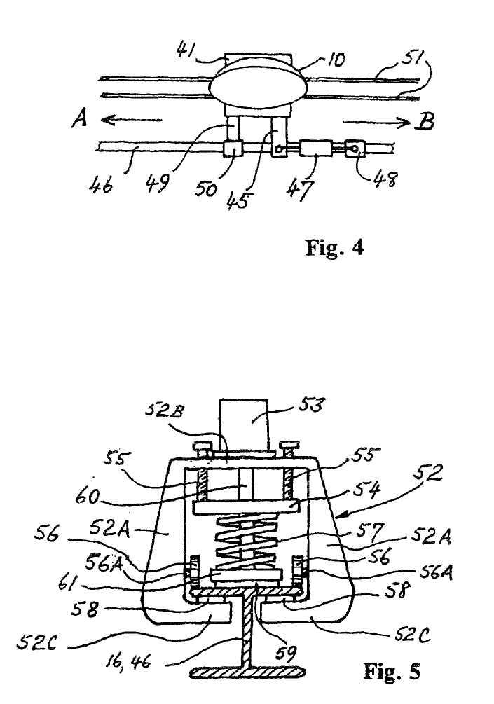

FIG. 4 illustrates the use of the present invention in a situation where the ring member is replaced with an arcuate member 46 of finite length but with an infinite radius of curvature. That is, the arcuate member 46 is, in practice, a linear member. Accordingly, for convenience and to reflect the reality of the situation, in the following description of FIG. 4, reference will be made to “linear member 46”.

In the arrangement shown in FIG. 4, a body 41, which may be the base frame of a dish antenna which is part of an array of dish antennae set up as an interferometer, is to be moved in the direction A or B, parallel to the linear member 46. A rigid arm 45 extends from the base frame 41 to overlie the linear member 46. One end of a double-acting ram 47 is connected to the end of the arm 45 which is remote from the base frame 41. The other end of the double-acting ram 47 is connected to an actuator clamp 48 which is mounted on the linear member 46. A second rigid arm 49 extends from the base frame 41 to overlie the linear member 46. An auxiliary clamp 50 is mounted on the linear member 46 and is rigidly connected to the arm 49.

To move the body 41 in the direction A or B, the actuator clamp 48 is clamped to the linear member 46. The clamp 50 is released and is free to move along the member 46. The double-acting ram 47 is actuated and, since the end attached to 10 the clamp 48 cannot move, the rigid arm 45 (with its support frame 4 and the dish 40) is moved by the expansion or contraction of the ram 47. As the support frame 41 moves, so does the arm 49 and the clamp 50. When the ram 47 has reached the end of its intended throw, the auxiliary clamp 50 is clamped to the linear member 46 and the clamp 48 is released. The clamp 48 is then moved, under the action of the ram 47, along the linear member 46 to a new position. As soon as it is repositioned, the clamp 48 is actuated, so that it is again clamped onto the member 46. This sequence is then repeated.

Normally, the base frame 41 will be mounted for movement along a pair of parallel rails 51, which are also parallel to the elongate direction of the linear member 46. If the dish antenna is large and heavy, the linear member 46, and the arms 45 and 49 with their associated linear expansion and contraction device 47 and the clamps 48 and 50, may be duplicated on the other side of the rails 51. With such an arrangement, the base frame 41 will be moved by the pair of hydraulic rams (or similar devices) 47 and their associated clamps, acting in synchronism with each other.

The clamps shown schematically in FIGS. 1 to 4 may be any one of a number of different clamp constructions, depending on the nature of the ring (or arcuate) member 16 or the linear member 46. Normally, all the clamps used in the body rotation arrangement will have the same construction. The important feature of each clamp is that (a) the clamp applies a clamping force to the member 16 or 46 until the clamping force is deliberately removed, and (b) in the event of a failure of the 5 power applied to the system controlling the movement of the body, the clamping force applied by the clamp to the member 16 or 46 is maintained (if the force has been applied at the time of the power failure) or is immediately applied. Thus, if the power supply fails, the body being moved will remain in its position at the time of the power failure, clamped to the member 16 or 46 (that is, in the case of a large dish antenna, in its most protected and stable position).

One clamp construction, which has been devised by the present inventor for use as a clamp in the arrangements depicted in FIGS. 1 to 4 and described above, when the member 16 or 46 is an I-beam, is illustrated in FIG. 5. In FIG. 5, an end view of a clamp mounted on an I-beam is shown. The clamp has a yoke 52. The yoke 52 15 comprises a pair of side members 52A which are connected at their tops by a cross-member 52B. A respective arm 52C extends inwardly from the bottom of each side member 52A. Each arm 52C carries, on its upper surface, a friction pad 58. A further, central friction pad 59 is mounted on a plate 61 that is securely attached to the lower end of a vertical shaft 60. The shaft 60 passes through an 20 aperture in the cross-member 52B, and also through an aperture in a second plate 54 that is positioned below the cross-member 52B and above the plate 61. The shaft 60 can move freely, vertically, within the aperture in the second plate 54 and its associated aperture in the cross-member 52B. A strong helical spring 57 is positioned substantially coaxially with, and surrounding, the shaft 60, between 25 the plates 54 and 61. Four bolts 55 (which, preferably, are substantially equispaced from each other and are positioned symmetrically relative to the shaft 60) pass through respective threaded apertures in the cross-member 52B and are screwed down until the force applied by the helical spring 57 to the plate 61 causes the friction pad 58 and the friction pads 59 to exert a predetermined force against the top horizontal arm or flange of the I-beam 16 or 46. This predetermined force is sufficient to clamp the yoke 52 to the I-beam, and ensure no movement of the clamp assembly when the ram 17 or 47 is activated to move (rotate) the body 11 or 41.

At the end of the throw of the ram 17 or 47, when the movement of the body ceases, the clamp is deactivated. This is done by actuation of a shaft lifting device 53, by a control signal. The shaft lifting device 53 is mounted on the cross-member 52B. The shaft lifting device, when actuated, lifts the shaft 60 against the force established (on the plate 61) by the helical spring 57. Lifting (raising) the shaft 60 also lifts the plate 61 and its attached friction pad 59, thus removing the force exerted on the I-beam by the friction pads 58 and 59. The shaft lifting device 53 may comprise a hydraulic ram, a solenoid, a cam, or any other suitable device which can be operated to lift the shaft 60.

With the clamp removal device 53 actuated, the yoke 52 (and with it, the components mounted on it) can be moved freely along the I-beam or rail 16 or 46 under the action of the hydraulic ram 17 or 47. Movement along the I-beam or rail is facilitated by wheels 56 which are mounted on respective axles 56A which extend inwardly from the yoke 52. When the yoke 52 has reached its new position, the clamp removal device 53 is deactuated, the pads 58 and 59 (by virtue of the increased compression of the spring 57) are moved to contact and again exert a force against the I-beam, so that the clamp is once again clamped onto the I-beam. Movement of the body 11 or 41 may then be effected as the ram 17 or 47 is expanded or contracted.

FIG. 6 depicts a clamp which acts in a similar manner to the clamp shown in FIG. 5, but is constructed to clamp against a “wall” or similar circular or arcuate foundation member 16, or against a linear wall member 46. This clamp has a yoke 62, which is a different shape from the yoke of the FIG. 5 clamp, with a horizontal member 62A and arms 62B extending downwardly, one at each end of the horizontal 5 member 62A. One arm 62B carries a friction pad 68 which is positioned adjacent to one side face of the “wall” 16 or 46. A second friction pad 69 is mounted on a plate 71 that is securely attached to the end of a shaft 70. The shaft 70 passes through (and can move freely within) an aperture in a plate 64 and an aperture in a support plate 72. The support plate 72 is mounted on the other arm 62B of the yoke 62. 10 The plate 64 is between the plate 71 and the support plate 72. Four bolts 55, similar to the four bolts 55 of the clamp illustrated in FIG. 5, pass horizontally through respective threaded apertures in the support plate 72 and bear against one surface of the plate 64. A strong helical spring 57 is positioned substantially coaxially with, and surrounding, the shaft 70, between the plates 64 and 71. The bolts 55 are tightened to move the plate 64 towards the plate 71, thus compressing the strong helical spring 57 and causing a force to be applied to the plate 71 and thus by the friction pads 68 and 69 to the side faces of the wall 16 or 46. A shaft lifting device 53, which performs a similar function to the shaft lifting device in FIG. 5, is also mounted on the support plate 72.

The clamp shown in FIG. 6 is operated in a manner similar to the clamp shown in FIG. 5, with the shaft lifting device 53 actuated by a control signal to move the shaft 70, and with it the plate 71, horizontally away from the wall member 16 or 46, to thereby remove the clamping force and permit the clamp to be repositioned on the wall 16,46. Wheels 66, which contact the top face of the wall 16 or 46, are mounted on respective axles 66A to facilitate the movement of the yoke 62 (and its attachments) along the wall 16 or 46.

Other forms of clamps may be used with the rotation or linear movement arrangements of the present invention, provided they have the essential operational features noted above (in particular, the feature that, in the event of a power failure, the clamping force is maintained, or is re-established, thereby ensuring that the body is held firmly against the member 16 or 46).

The drive mechanisms and clamps illustrated in the accompanying drawings and described above are simpler, less expensive and more likely to be trouble free than the conventional drive mechanisms and clamps used in the rotation of large dish antennae. They can also be used, with advantage, to rotate, or move linearly (when the radius of curvature of the rotation is infinite), other bodies.

Thus, generally, the apparatus for the rotation of a large body of the present invention, such as the base frame of a solar energy collector having a large reflective dish, about an axis utilizes a ring member or arcuate member. An actuator clamp is movable along the ring or arcuate member when it is not clamped to it. The actuator clamp is connected to one end of an expansion and contraction device, such as a hydraulic ram. The other end of the hydraulic ram is connected to the body, to a projection from the body, or to a rigid arm that is securely connected to the body. With the actuator clamp firmly clamped to the ring or arcuate member, actuation of the hydraulic ram causes the body to rotate about the axis. Stepwise rotation of the body is effected by releasing the clamp, moving it to a new position of the ring or arcuate member by further actuation of the hydraulic ram, re-clamping it onto the ring or arcuate member, then re-actuating the hydraulic ram. Using short throws of the ram, and rapid actuation of the clamp and the ram, quasi-continuous rotation of the body is achieved. At least one auxiliary clamp, releasably clampable to the ring or arcuate member and connected to the body, may be provided. The (or each) auxiliary clamp can be used to hold the body in position while the actuator clamp is released and moved, under the action of the ram, to a new position on the ring or arcuate member. If the (or each) auxiliary clamp is connected to the body by a respective additional hydraulic ram, the auxiliary clamp(s) may be used to effect continuous rotation of the body. If the ring or arcuate member has an infinite radius of curvature, the combination of an actuator clamp and an associated hydraulic ram can be used to effect controlled linear movement of a body, typically along rails.

It should be appreciated that the embodiments of the present invention which are illustrated in the accompanying drawings and described above are examples only of realizations of the present invention, which may be varied or modified without departing from the present inventive concept, as defined by the following claims.

### INDUSTRIAL APPLICABILITY

As noted in the introductory part of this specification, the present invention was developed to provide effective actuation and control of the rotation of structures on which are mounted large dish antennae, such as the dish antennae used in radio telescopes, solar energy collectors and satellite communication systems. It was conceived specifically for the control of a particular large solar energy collector dish antenna. However, as has been shown in the above description of the invention, it is not limited to this application or to dish antennae generally, but may be used to control, effectively and economically, stepwise, quasi-continuous, or (in some embodiments) truly continuous rotation of a wide range of large bodies.

What is claimed is:

1. Apparatus for effecting controlled rotation of a body about an axis, said apparatus comprising:
a ring member or arcuate member, said ring member or arcuate member having an uppermost surface which is positioned in a plane; the centre of curvature of said ring member or arcuate member being at said axis of rotation of said body; said axis of rotation being perpendicular to said plane, such that:
a) an actuator clamp is mounted on said ring member or arcuate member for movement therealong, said actuator clamp being releasably clampable onto said ring member or arcuate member; and
b) an expansion and contraction device, having two end connections that are moveable substantially towards and away from each other for a predetermined throw of said device, has one of said end connections connected to said actuator clamp and the other of said end connections connected to said body, or to a rigid arm or projection connected rigidly to said body, and therefore rotatable about said axis with said body; and
whereby, (1) when said actuator clamp is clamped onto said ring member or arcuate member and said expansion and contraction device is actuated to move said end connections towards or away from each other, said body (or said rigid arm or projection, and hence said body) is rotated about said axis of rotation, and (2) when said expansion and contraction device has reached the end of its throw, said actuator clamp may be released, then moved along said ring member or arcuate member to a fresh position thereon, by the further actuation of said expansion and contraction device, so that said actuator clamp may be clamped again onto said ring member or arcuate member to permit further rotational movement of said body by further actuation of said expansion and contraction device.

2. Apparatus as defined in claim 1, in which said expansion and contraction device is a linear expansion and contraction device.

3. Apparatus as defined in claim 1, further characterized in that at least one auxiliary clamp is mounted on said ring member or arcuate member for movement therealong, said at least one auxiliary clamp being releasably clampable onto said ring member or arcuate member; said at least one auxiliary clamp being connected to said body or to a respective rigid arm or projection that is rigidly connected to said body.

4. Apparatus as defined in claim 3, in which
a) said expansion and contraction device is a first expansion and contraction device, and
b) said at least one auxiliary clamp is connected to said body, or to a rigid arm or projection rigidly connected to said body, by a respective additional expansion and contraction device.

5. Apparatus as defined in claim 1, in which the throw of said expansion and contraction device is variable.

6. Apparatus as defined in claim 5, in which said expansion and contraction device is a double-acting hydraulic ram.

7. Apparatus as defined in claim 1, including a computer which controls said apparatus in response to signals from a shaft encoder on said axis.

8. Apparatus as defined in claim 3, including a computer which controls said apparatus in response to signals from a shaft encoder on said axis.

9. Apparatus as defined in claim 1, in which said ring member or arcuate member is an arcuate member having a finite length and an infinite radius of curvature, whereby said arcuate member is essentially a linear member.

10. Apparatus as defined in claim 1, in which said member along which said actuator clamp is moveable comprises an I-beam having a centrally positioned vertical member separating an upper horizontal flange and a lower horizontal flange, and said or each clamp comprises a yoke adapted to fit onto said I-beam, said yoke comprising a pair of side members connected at the top thereof by a cross-member, further characterized in that:
a) a respective arm extends inwardly from the lower end of each of said side members; a respective first friction pad being mounted on the top surface of each of said arms, underneath said upper flange;
b) a vertical shaft extends through a centrally positioned aperture in said cross-member, said shaft being freely moveable vertically within said aperture;
c) a first plate is securely mounted on the lower end of said vertical shaft, said first plate having a substantially horizontal lower surface; a second friction pad being affixed to the lower surface of said first plate; said second friction pad being above the top surface of said upper flange;
d) a second plate is positioned above said first plate and below said cross member, with said vertical shaft passing through, and being freely moveable vertically within, an aperture in said second plate;
e) a helical spring is positioned between said first plate and said second plate, said helical spring being substantially coaxial with, and surrounding the lower portion of, said vertical shaft;
f) four bolts pass vertically through respective, symmetrically positioned, threaded apertures in said cross-member and the lower ends of said bolts bear against the upper surface of said second plate; said bolts being adjustable to control the position of said second plate relative to said cross-member, and thereby control a force applied by said helical spring to said first plate, and thus to control a force applied by said second friction pad to the top surface of said upper flange and a force applied to the underside of said upper flange by said first friction pads;
g) a shaft lifting device is mounted on said cross-member; said shaft lifting device being actuated on receipt of a control signal to lift said shaft vertically against the force applied by said helical spring to said first plate, to thereby remove the forces applied by said friction pads to said upper flange; and
h) at least two wheels are mounted on respective axles which extend from said yoke; each wheel being adapted to roll on the top surface of said upper flange when said shaft lifting device is actuated.

11. Apparatus as defined in claim 1, in which said member along which said actuator clamp is moveable comprises a wall having a pair of side faces and a top face, and said or each clamp comprises a yoke adapted to fit over said top face, said yoke comprising a horizontal member with a pair of vertical arms extending downwardly from respective ends of said horizontal member fiber characterized in that:
a) a first friction pad is mounted on one of said arms, adjacent to one face of said wall, and a support plate is mounted on the inside surface of the other of said arms, said support plate having substantially planar faces which are substantially vertical;
b) a horizontal shaft extends through an aperture in said support plate, said shaft being freely moveable horizontally within said aperture;
c) a second plate is securely mounted on the end of said horizontal shaft which is remote from said support plate; said second plate having substantially planar surfaces which are orthogonal to the elongate direction of said shaft; a second friction pad being affixed to the surface of said second plate which is remote from said support plate; said second friction pad being adjacent the other face of said wall;
d) a third plate is positioned between said second plate and said support plate with said horizontal shaft passing through, and being freely moveable horizontally within, an aperture in said third plate;
e) a helical spring is positioned between said second plate and said third plate, said helical spring being substantially coaxial with, and surrounding, the portion of said horizontal shaft that is between said second and third plates;
f) four bolts pass horizontally through respective, symmetrically positioned, threaded apertures in said support plate so that the ends of said bolts bear against a surface of said third plate; said bolts being adjustable to control the position of said third plate relative to said support plate, and thereby control a force applied by said helical spring to said second plate, and thus to control a force applied by said second friction pad to said other face of said wall and a force applied to said one face of said wall by said first friction pad;
g) a shaft lifting device is mounted on said support plate; said shaft lifting device being actuated on receipt of a control signal to move said shaft horizontally against the force applied by said helical spring to said second plate, to thereby remove the forces applied by said friction pads to said faces of said wall; and
h) at least two wheels are mounted on respective axles which extend from said yoke; each wheel being adapted to roll on the top face of said wall when said shaft lifting device is actuated.

12. Apparatus as defined in claim 1, in which said body is a large reflecting dish of a solar energy collector, mounted on a base frame.
